(19) United States
(12) Patent Application Publication
(10) Pub. No.: US 2004/0141101 A1
(43) Pub. Date: Jul. 22, 2004

(54) Display apparatus

(75) Inventors: Toru Osu, Osaka (JP); Hisao Kobayashi, Kyoto (JP); Kazumi Teratani, Osaka (JP); Shinya Ogasawara, Osaka (JP)

Correspondence Address: MCDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/671,478

(22) Filed: Sep. 29, 2003

(30) Foreign Application Priority Data
Sep. 30, 2002 (JP) P2002-286723

(51) Int. Cl. G02F 1/1333

(52) U.S. Cl. 349/58

(57) ABSTRACT

A display apparatus according to the present invention comprises: a casing having an opening; a display panel, which is housed inside of the casing and has an image display region facing to the opening; and a protecting panel for closing the opening. The protecting panel is retained in such a manner that a marginal portion of the protecting panel is held between the display panel and the casing via a resin foam.

### FIELD OF THE INVENTION

The present invention relates to a planar type display apparatus such as a plasma display apparatus or a liquid crystal display apparatus and, more particularly, to a display apparatus having a protecting panel for protecting an image display screen of a display panel.

### BACKGROUND OF THE INVENTION

Planar type display apparatuses include a plasma display apparatus provided at the front surface thereof with an electromagnetic wave absorbing filter serving as a protecting panel, as disclosed in, for example, Japanese Patent Application Laid-open No. 352,897/1999.

In such a plasma display apparatus, an opening is formed in a manner facing an image display region of a plasma display panel at a front casing on a front side in a casing containing the plasma display panel and the like therein. An electromagnetic wave absorbing filter serving as a protecting panel is disposed is such a manner so as to close the opening. The electromagnetic wave absorbing filter is securely fixed at the marginal portion thereof to a frame disposed around the opening via double-sided tape.

The double-sided tape has flexibility, and therefore, even if the electromagnetic wave absorbing filter is deformed by heat generated at the time of energization of the display apparatus, the thermal deformation is designed to be absorbed by elastic deformation of the double-sided tape. Thus, it is possible to prevent any uneven deformation of the electromagnetic wave absorbing filter caused by the heat generated at the time of the energization of the display apparatus or any generation of moires (interference fringes) caused by contact of the electromagnetic wave absorbing filter with the image display region of the plasma display panel due to uneven deformation.

However, in the case where a coefficient of linear expansion as a physical value of a material of the electromagnetic wave absorbing filter is greater than that of the double-sided tape, the thermal deformation of the electromagnetic wave absorbing filter cannot be absorbed only by the elastic deformation of the double-sided tape.

Furthermore, a wall is formed around the frame of the casing in such a manner so as to surround the marginal portion of the electromagnetic wave absorbing filter. Although the electromagnetic wave absorbing filter is fixed between the marginal portion and the wall with a clearance via the double-sided tape, the outward expansion of the electromagnetic wave absorbing filter is interfered with by the wall of the casing if expansion due to the thermal deformation of the electromagnetic wave absorbing filter is greater than the clearance. In this case, the electromagnetic wave absorbing filter may be deformed in an uneven manner, or moires may be generated due to the contact of the electromagnetic wave absorbing filter with the image display region on the plasma display panel.

The above-described problem may arise not only by the heat but also by moisture or the like.

### SUMMARY OF THE INVENTION

A display apparatus in a preferred embodiment according to the present invention comprises: a casing having an opening; a display panel, which is housed inside of the casing and has an image display region facing the opening; and a protecting panel for closing the opening; wherein the protecting panel is held in such a manner that a marginal portion of the protecting panel is pressed against at least either one of the display panel and the casing.

It is preferable that the marginal portion of the protecting panel should be retained between the display panel and the casing.

It is preferable that the marginal portion of the protecting panel should be held via a restorative member having flexibility.

The display apparatus according to the present invention can be applied to a liquid crystal display apparatus, a plasma display apparatus, an organic EL display apparatus and the like.

### BRIEF DESCRIPTION OF THE DRAWINGS

These and other objects as well as advantages of the invention will become clear by the following description of preferred embodiments of the invention with reference to the accompanying drawings, wherein:

FIG. 1 is a front view showing a liquid crystal display apparatus of a preferred embodiment according to the present invention;

FIG. 2 is a longitudinal side view showing the liquid crystal display apparatus of FIG. 1;

FIG. 3 is a perspective view, partly broken away, showing the liquid crystal display apparatus of FIG. 1;

FIG. 4 is a perspective view illustrating the state in which a casing of FIG. 3 is removed;

FIG. 5 is a perspective view illustrating the state in which a protecting panel of FIG. 4 is removed;

FIG. 6 is a perspective view showing the protecting panel;

FIG. 7 is a cross-sectional view, partly enlarged, of FIG. 2;

FIG. 8 is a longitudinal side view showing a liquid crystal display apparatus of another preferred embodiment according to the present invention; and

FIG. 9 is a cross-sectional view, partly enlarged, of FIG. 7.

In all these figures, like components are indicated by the same numerals.

### DETAILED DESCRIPTION OF THE PREFERRED EMBODIMENTS

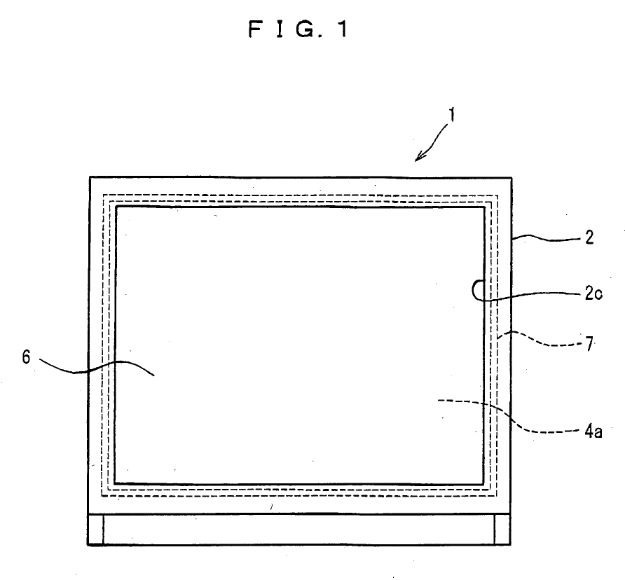

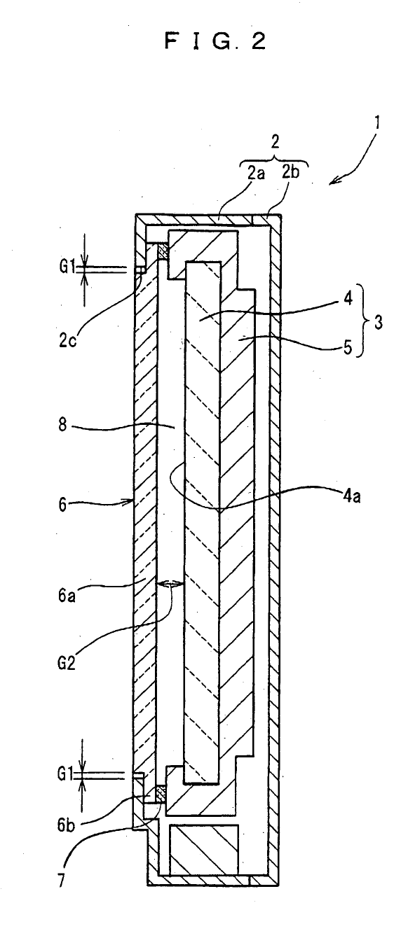

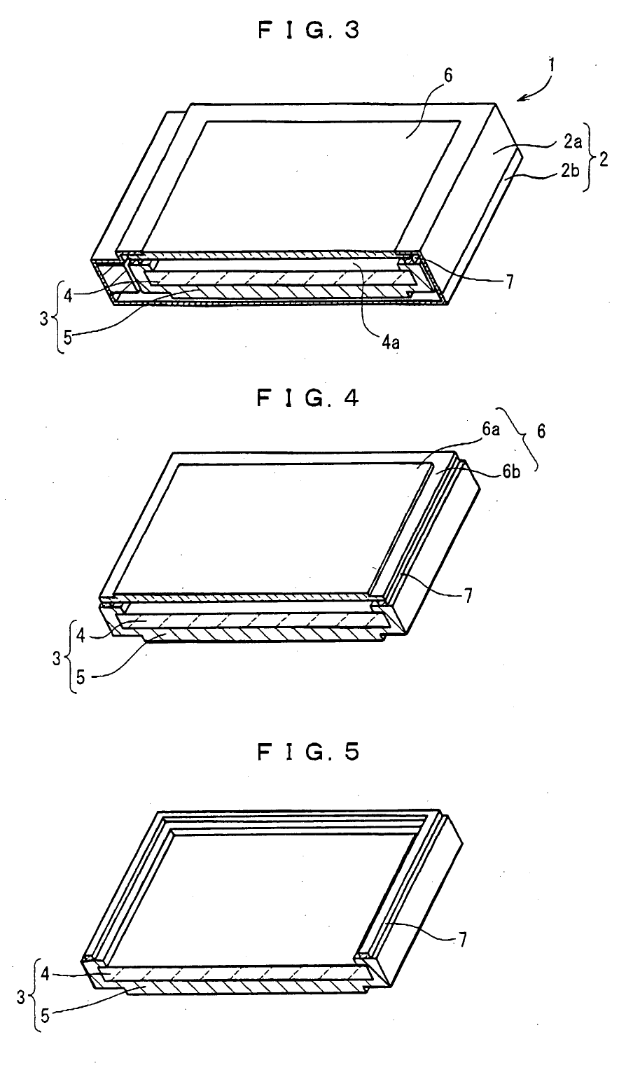

Preferred embodiments of a liquid crystal display apparatus according to the present invention are described below in reference to the accompanying drawings. FIG. 1 is a front view showing a liquid crystal display apparatus of a preferred embodiment according to the present invention; and FIG. 2 is a longitudinal side view showing the liquid crystal display apparatus. A liquid crystal display apparatus 1 is provided with a casing 2. The casing 2 should be preferably made of an electrogalvanizing steel sheet (SECC) having a coating. The casing 2 can be separated into two parts, that is, a front casing 2a and a rear casing 2b. The front casing 2a has a rectangular opening 2c on a front side thereof.

A liquid crystal panel 3 serving as a display panel is housed inside of the casing 2, and is provided with a panel body 4 and a panel frame 5. The panel body 4 includes an image display region 4a on a front side thereof. The panel frame 5 is made of aluminum or the like, and is adapted to contain the panel body 4 therein and hold the outer periphery of the panel body 4.

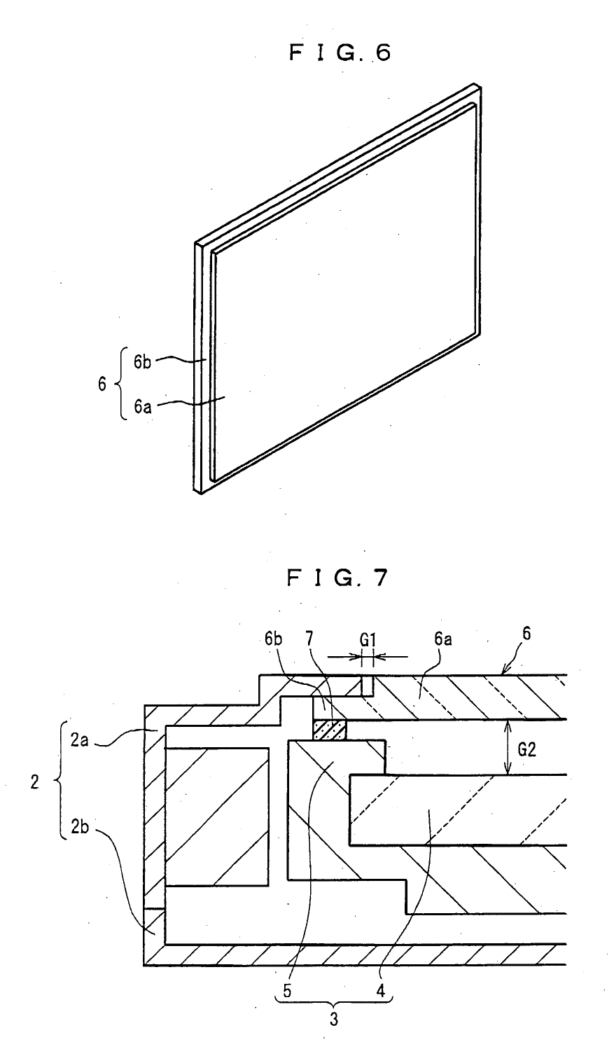

The image display region 4a of the panel body 4 faces the opening 2c of the front casing 2a. A protecting panel 6 is fixed in such a manner as to close the opening 2c of the front casing 2a, so as to protect the image display region 4a in the liquid crystal panel 3. As shown in FIG. 6, the protecting panel 6 is provided with a rectangular central portion 6a having an area slightly smaller than that of the opening 2c of the front casing 2a and a marginal portion 6b having a thickness smaller than that of the central portion 6a. The protecting panel 6 may be flat in the same thickness.

The protecting panel 6 is made of, for example, a transparent material such as an acrylic resin. The protecting panel 6 is configured such that the front surface of the central portion 6a fitted to the opening 2c of the front casing 2a is substantially flush with the front surface of the front casing 2a without any step when the protecting panel 6 is fixed to the casing 2. A clearance G1 is set between the side surface of the central portion 6a and the end surface of the opening 2c of the front casing 2a in consideration of expansion caused by heat of the protecting panel 6, as shown in FIG. 2, in the state in which the central portion 6a is fitted to the opening 2c of the front casing 2a.

As shown in FIG. 7, the protecting panel 6 is retained between the front casing 2a and the panel frame 5 of the liquid crystal panel 3 while the marginal portion 6b is held therebetween.

A resin foam (i.e., a sponge) 7 serving as a restorative member having flexibility is interposed between the marginal portion 6b of the protecting panel 6 and the panel frame 5 of the liquid crystal panel 3. The resin foam 7 has a rectangular cross-sectional shape, and the resin foam 7 is securely fixed to the protecting panel 6 at a surface in contact with the protecting panel 6. The resin foam 7 may be securely fixed to not the protecting panel 6 but the panel frame 5 of the liquid crystal panel 3. However, since the liquid crystal panel 3 may be replaced with another one at the time of periodical maintenance, the resin foam 7 should be preferably fixed onto the side of the protecting panel 6 so that the liquid crystal panel 3 can be independently replaced with another one.

It is preferable that the resin foam 7 should be secured to the protecting panel 6 or the panel frame 5 from the viewpoint of enhancement of workability in assembling the apparatus.

The thickness of the resin foam 7 is dimensionally set such that compression is applied in a direction of the thickness of the protecting panel 6 in the state in which the liquid crystal display apparatus 1 is assembled. Consequently, external force can be applied so as to press-fit (i.e., press) the protecting panel 6 to (against) the front casing 2a at all times.

In this manner, the protecting panel 6 is retained between the front casing 2a and the panel frame 5 of the liquid crystal panel 3 via the resin foam 7, and therefore, the protecting panel 6 is never mechanically connected (i.e., fixed) with respect to the casing 2.

As a consequence, a phenomenon of outward expansion due to thermal expansion of the protecting panel 6 caused by the inside heat generation at the time of the energization of the apparatus is not prevented, or a phenomenon of contraction due to thermal contraction after the stoppage of the energization is not prevented. This reduces the uneven deformation of the protecting panel 6 or the generation of moires caused by the contact of the protecting panel 6 with the image display region 4a of the liquid crystal panel 3 due to the deformation.

The protecting panel 6 is held via the resin foam 7 having flexibility and restorability, so that the protecting panel 6 is pressed against the front casing 2a by the compressive repulsion of the resin foam 7, thereby absorbing any play, and thus, the protecting panel 6 can be securely held.

As shown in FIG. 2, the image display region 4a of the liquid crystal panel 3 is shielded by the resin foam 7 and the protecting panel 6, and therefore, a closed space 8 is defined inside of the casing 2 by the protecting panel 6, the resin foam 7 and the liquid crystal panel 3.

Consequently, in the case where dust adheres to the image display region 4a when assembling the liquid crystal display apparatus is removed in advance, the dust can be prevented from adhering to the image display region 4a after the assembling work.

The present preferred embodiment is exemplified by the liquid crystal display apparatus 1 of, for example, 18 inch, in which the clearance G1 of, for example, about 0.2 mm is formed between the end surface of the opening of the front casing 2a and the side surface of the central portion 6a of the protecting panel 6. The clearance G1 can prevent any limitation of the expansion by the front casing 2a even if the protecting panel 6 is expanded due to the inside heat generation at the time of the energization of the apparatus.

The thickness of the resin foam 7 is, for example, 3 mm. The protecting panel 6 is retained by the pressing force such that the thickness of the resin foam 7 becomes about 1 mm. At this time, a clearance G2 between the inner surface of the protecting panel 6 and the image display region 4a of the liquid crystal panel 3 is, for example, about 1.5 mm.

An open-cell ethylene foam is preferable as the resin foam 7. One of the open-cell ethylene foams is “OPCELL” (trade name) manufactured by SANWA KAKO CO., LTD.

As described above, the protecting panel 6 is not secured to the front casing 2a or the panel frame 5 at the marginal portion 6b thereof, but is held between the front casing 2a and the panel frame 5 via the resin foam 7. Consequently, the protecting panel 6 can be freely expanded or contracted even if the protecting panel 6 is thermally deformed due to the inside heat generation at the time of the energization of the apparatus, thereby solving the problem of the generation of the moires due to the contact of the protecting panel 6 with the image display region 4a of the liquid crystal panel 3 caused by the uneven deformation. The prevention is effective in the case where the protecting panel 6 is linearly expanded not only by the heat but also by moisture.

The resin foam 7 having elasticity can absorb the clearance generated when the protecting panel 6 is held between the front casing 2a and the panel frame 5, thereby preventing any play or the like of the protecting panel 6 after the assembling work.

Furthermore, the image display region 4a of the liquid crystal panel 3 is shielded by the resin foam 7 and the protecting panel 6, thereby preventing any intrusion and adhesion of the dust into and to the image display region 4a of the liquid crystal panel 3 after the assembling work.

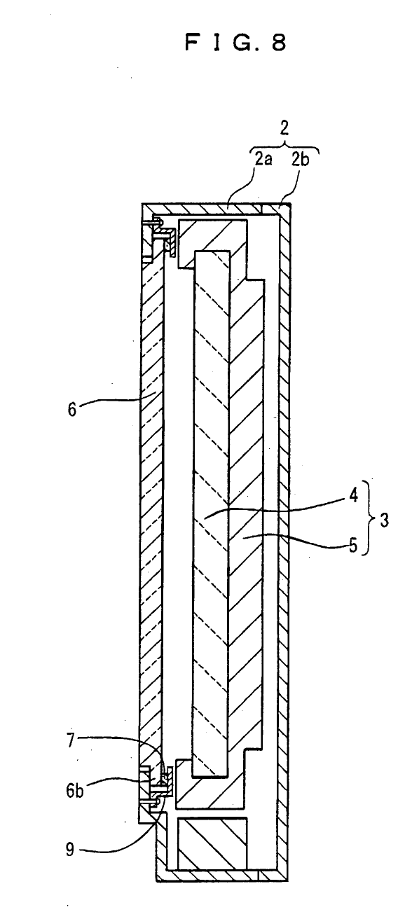

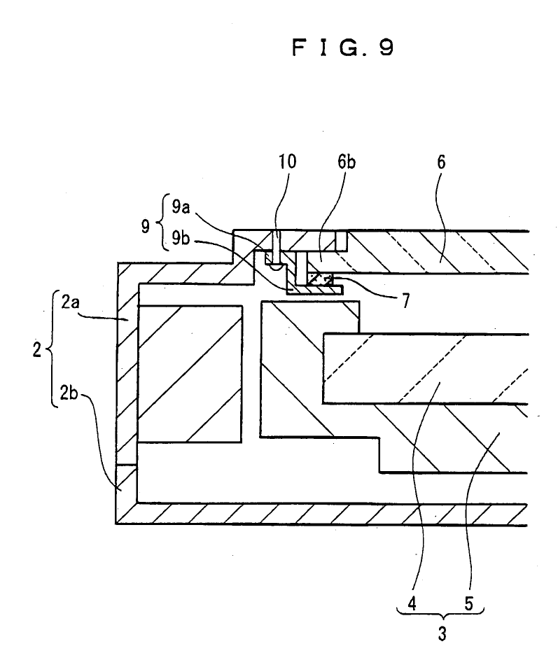

A liquid crystal display apparatus of another preferred embodiment according to the present invention is described below in reference to FIGS. 8 and 9. A protecting panel 6 is retained between the inner surface of a front casing 2a and bent holding members 9 screwed at the inner surface, and further, a resin foam 7 is securely fixed to a marginal portion 6b of the protecting panel 6.

The four holding members 9 are disposed in a manner corresponding to sides of the rectangular protecting panel 6, respectively. The holding member 9 is provided with a fixed portion 9a to be fixed to the front casing 2a via a screw 10 and a holding portion 9b for holding the protecting panel 6.

The holding member 9 is configured such that the holding member 9 compresses the resin foam 7 in the same manner as in the foregoing preferred embodiment when the holding member 9 is screwed at the inner surface of the front casing 2a, so as to hold the protecting panel 6 between the inner surface of the front casing 2a and the holding member 9. The other configurations are identical to that in the foregoing preferred embodiment.

The holding member 9 may be disposed on a side of a liquid crystal panel 3, for example, in a panel frame 5, so as to hold the protecting panel 6 between the panel frame 5 and the holding members 9.

As a restorative member having flexibility, it is acceptable to use rubber, a material of an elastomer or the like.

Otherwise, a restorative member having flexibility may be omitted.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A display apparatus comprising:
a casing having an opening;
a display panel, which is housed inside of the casing and has an image display region facing to the opening; and
a protecting panel for closing the opening;
the protecting panel being held in such a manner that a marginal portion of the protecting panel is pressed against at least one of the display panel and the casing.

2. A display apparatus as claimed in claim 1,
wherein holding members for holding the protecting panel therein are fixed to the casing, and the protecting panel is held in such a manner that the marginal portion of the protecting panel is retained between the casing and the holding members.

3. A display apparatus as claimed in claim 1,
wherein the marginal portion of the protecting panel is retained between the display panel and the casing.

4. A display apparatus as claimed in claim 2,
wherein the marginal portion of the protecting panel is held via a restorative member having flexibility.

5. A display apparatus as claimed in claim 3,
wherein the marginal portion of the protecting panel is held via a restorative member having flexibility.

6. A display apparatus as claimed in claim 5,
wherein the restorative member is interposed between the marginal portion of the protecting panel and the display panel, and the image display region of the display panel is shielded by the restorative member and the protecting panel.

7. A display apparatus as claimed in claim 6,
wherein the display panel is provided with a display panel body having the image display region and a panel frame for holding the outer periphery of the display panel body, and further, the restorative member is interposed between the marginal portion of the protecting panel and the panel frame.

8. A display apparatus as claimed in claim 7,
wherein the restorative member is a foam, the foam being bonded, at a surface in contact with the marginal portion of the protecting panel or the panel frame, to the marginal portion or the panel frame.
